(19) United States
(12) Patent Application Publication
(10) Pub. No.: US 2005/0130111 A1
(43) Pub. Date: Jun. 16, 2005

(54) Electronic educational game

(76) Inventors: Alton B. Otis JR., Port Townsend, WA (US); Gary Paugh, Long Beach, CA (US); James Whitney, San Juan Capistrano, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/975,712

(22) Filed: Oct. 27, 2004

Related U.S. Application Data
(60) Provisional application No. 60/524,995, filed on Nov. 24, 2003.

(51) Int. Cl. G09B 3/00

(52) U.S. Cl. 434/322

(57) ABSTRACT

An electronic educational game comprising a learning aid that is adapted to receive and identify a lesson card, and to subsequently accept user input and provide responses to such inputs where the responses provided are at least partially determined by the identity of the lesson card, where such identity is determined by using an optical code reader that is part of the learning aid to read a plurality of optical code strips on the lesson card.

### PRIORITY CLAIM

This application claims the benefit of the United States provisional patent application entitled “Phonics Pad”, filed on Nov. 24, 2003, and having Ser. No. 60/524,995, the entire contents of which are incorporated herein by reference.

### FIELD OF THE INVENTION

The field of the invention is electronic educational games.

### BACKGROUND OF THE INVENTION

Various types of educational games are known. However, there is a continuing need for games and game devices that provide improvements in ease of use, durability, and cost, and in the speed, amount, and quality of information transferred and/or skills taught.

### SUMMARY OF THE INVENTION

The present invention is directed to an electronic educational game comprising a learning aid that is adapted to receive and identify a lesson card, and to subsequently accept user input and provide responses to such inputs where the responses provided are at least partially determined by the identity of the lesson card.

According to one aspect, the present invention comprises an educational system comprising a learning aid and a lesson card, the learning aid being adapted to receive the lesson card and to use optical sensors to identify the lesson card. Preferably, the lesson card comprises at least one area that is configured to facilitate optical identification of the card. The area may comprise either black and white or colored indicia, such as stripes.

The indicia are preferably printed onto the surface of the card. However, those skilled in the art will appreciate that other means for applying the indicia are likewise suitable. For example, the indicia may alternatively be applied as decals or may be painted onto the card.

Preferably, the learning aid further comprises a plurality of switches and the lesson card has a plurality of images positioned thereon so as to overlay at least some of the plurality of switches.

According to another aspect, the present invention comprises an educational system comprising a learning aid that is adapted to receive a lesson card. The learning aid preferably comprises a plurality of switches positioned so as to underlie the lesson card when the lesson card is received by the learning aid. Each of the plurality of switches is preferably adapted to be at least momentarily activated by applying pressure to a portion of the lesson card.

The switches are in electrical communication with one or more output devices, such as lights or speakers. Activating at least one of the switches will typically result in output from at least one of the output devices.

Preferably, the learning aid comprises one or more sensors for obtaining data from the lesson card. The learning aid is preferably adapted to utilize the obtained data in determining whether output will be generated and also the form of the output, when any of the plurality of switches is activated.

The sensors preferably comprise at least one light sensor. However, those skilled in the art will appreciate that various other types of sensors are likewise suitable. For example, the sensors may alternatively comprise magnetic sensors or electrical conduction sensors. Of course, the type of sensors must correspond to the type of encoding use on the lesson card. Thus, if magnetic information encoding is used on the lesson card, then magnetic sensors must be used on the learning aid.

Preferably, at least one light sensor is part of a sensor array that includes a plurality of photocells and at least one light source. The sensor array preferably comprises a plurality of light sources wherein each light source is associated with a single photocell and light guide combination.

Each light guide of each of the combinations is typically adapted to direct reflected light from a light source of the combination to a photocell of the combination, and to inhibit the transmission of light from light sources of any other combination from reaching the photocell.

According to yet another aspect, the present invention comprises a method of making a lesson card, the method comprising forming an optically encoded area on the card in a pattern that facilitates identification of the card.

According to yet another aspect, the present invention comprises a method of educating comprising prompting a user to press one or more portions of a lesson card that is disposed proximate, e.g., upon, a learning aid, wherein the learning aid has identified the lesson card through the use of an optical code reader, and having the learning aid provide audio and/or visual feedback to the user after the user presses the one or more portions of the lesson card.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1A is a top perspective view of a learning aid and lesson card combination.

FIG. 1B is an exploded view of the combination of FIG. 1A.

FIG. 1C is a top view of the lesson card of FIG. 1A.

FIG. 2A is a perspective view of a light guide block.

FIG. 2B is a cutaway side view of the light guide block of FIG. 2A.

FIG. 2C is an illustration of the light path followed during operation of the learning aid.

### DETAILED DESCRIPTION

General

One aspect of the learning aid disclosed herein is that it utilizes light reflected off of appropriately marked data locations of the lesson card to identify the card. In another aspect, a separate combination of light emitters and sensors is dedicated to each data location. In yet another aspect, a plurality of light guides are used to prevent emitter/sensor combinations from interfering with each other. In still another aspect, the identity of the card affects the input/output relationships of the device. In yet another aspect, the existence and identity of the lesson card is verified several times each second. In yet another aspect, the identity of the card is determined by reading a code wherein the code contains information validating the identity of the card.

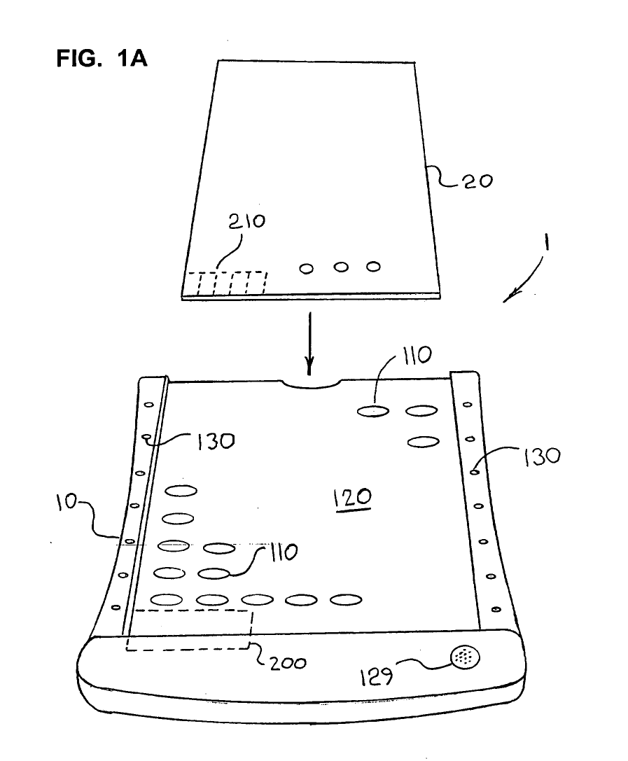

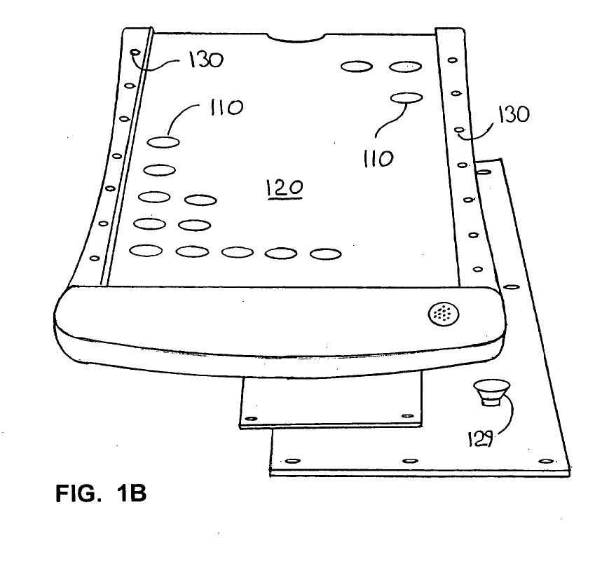

Referring first to FIGS. 1A through 1C, a learning system 1 comprises a learning aid 10 and at least one lesson card 20. In general, the learning system 1 is utilized by placing card 20 on and/or in a card holder of learning aid 10 and, in response to audio and/or visual prompts, applying pressure to portions of card 20, and listening to and/or viewing audio and/or visual feedback from learning aid 10.

As an example, a lesson card 20 might comprise a plurality of visual prompts in the form of illustrations of animals and the learning aid might generate the sound corresponding to a particular illustrated animal when the illustration or an area adjacent to the illustration is pressed.

As another example, a lesson card 20 might comprise a plurality of illustrations of objects and the learning aid might use pre-recorded speech to prompt selection of one or more illustrations and subsequently, in response to an illustration being selected, i.e., pressed, generate output that indicates whether the pressed illustration was one that a user was prompted to select.

Learning aid 10 is adapted to receive lesson card 20 in that it comprises a surface 120 that is sized and dimensioned to contact and support lesson card 20 when lesson card 20 is received by learning aid 10. Learning aid 10 comprises a plurality of switches 110 beneath surface 120 such that finger pressure imparted on portions of surface 120 by pressing portions of card 20 is sufficient to activate at least one of switches 110. Learning aid 10 also comprises an optical reader 200 that is used to identify card 20 by reading an identifier printed on card 20.

Learning card 20 is adapted to be used with learning aid 10 in that it includes data in the form of a printed identifier sufficient to identify card 20 to learning aid 10 and comprises a plurality of illustrations that function either as visual prompts or assist in providing visual feedback.

Learning Aid

Learning aid 10 comprises a plurality of inputs, preferably in the form of switches 110 positioned on card contact surface 120 to underlie lesson card 20 when lesson card 20 is received by the aid. Each of the plurality of switches 110 is adapted to be momentarily activated by manually applying pressure to a portion of the lesson card 20. The switches are electronically coupled to one or more output devices. Switches 110 are preferably provided in the form a key matrix containing approximately 90 positions to allow flexibility in the assignment of touch spots on the lesson cards.

In a preferred embodiment, output devices comprise a speaker 129 and two columns of ten light emitting diodes (LEDs) 130 positioned on the left and right sides of surface 120 such that activating at least one of the switches 110 will preferably result in output from at least one of the output devices 129, 130. Preferably, logic within the learning aid 10 determines what output, if any, is provided for the activation of a given switch 110, when a particular learning card 20 is being used.

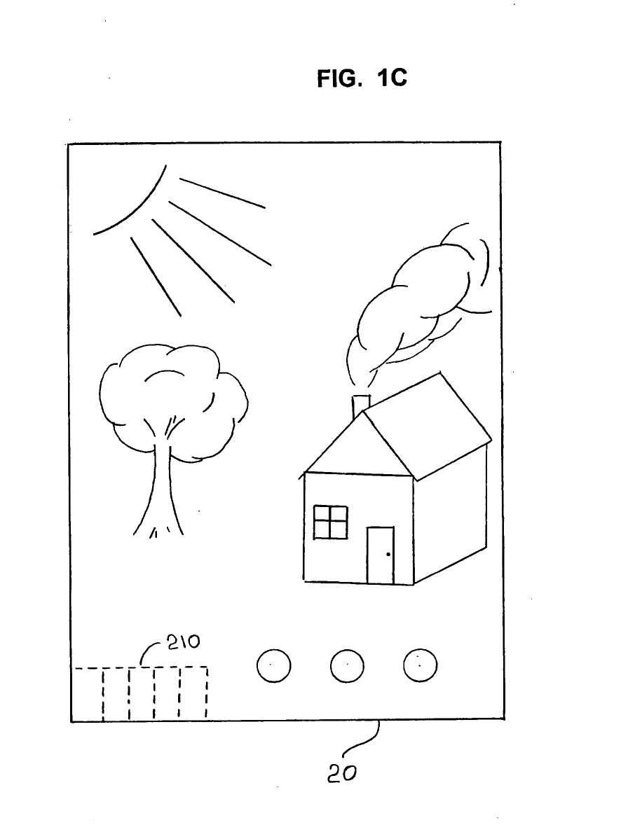

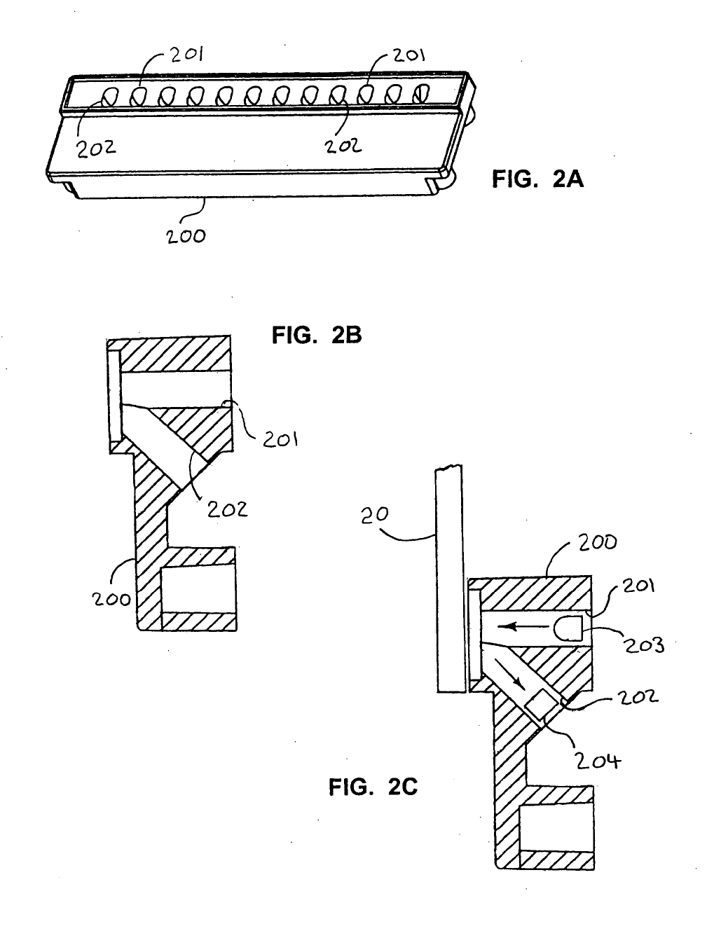

Learning aid 10 also comprises one or more sensors 204 (shown in FIG. 2C) as part of an optical code reader 200 for obtaining data from a lesson card 20 received by the learning aid 10, and the learning aid 10 is adapted to utilize the obtained data in determining whether output will be generated, and the form of the output, when any of the plurality of switches 120 is activated.

Learning aid 10 preferably also comprises sound data, preferably compressed sound data, that is expanded in real time and output in response to user actions. Such compressed sound data is preferably stored in read only memory. It is preferred that at least 6 hours of substantially non-repeated speech, music and sound effects be included in learning aid 10.

Learning aid 10 also preferably comprises one or more micro-controllers to provide overall control of learning aid 10.

Lesson Card Identification

Lesson card 20 comprises an identification code (hereinafter occasionally “card code”) 210 in the form of a plurality of black and white or colored regions (optical code strips) on a surface of card 20. The codes are preferably located at the bottom of each card surface on the back side thereof and are produced by a standard four color printing process with standard inks. The codes are preferably defined by 12 adjacent cells, with each cell measuring approximately 0.250″ wide by 0.375″ high. The cells may either be printed in black or white or printed in color.

The following exemplary learning card uses black and white printing of the cells. One card code (all black) is preferably reserved to allow detection of a “no-card” condition. All other cards preferably contain at least one white cell. The 12 cells contain 8 data bits for specifying the card contents and 4 check bits for verifying the validity of the code. The check bits are generated by an error detecting code polynomial and are able to detect all combinations of 1 or 2 bit errors and 92% or better of 3 or more bit errors.

Various error detection and/or error correction schemes are contemplated. Preferably, the present invention uses a check code that is more sophisticated than a simple parity check. Those skilled in the art will appreciate that various error detection and/or error correction methodologies are suitable.

Information other than the identification of the lesson card may optionally be included in the encoded information sensed by the learning aid. For example, the information may optionally include a version number or special instructions. Such special instructions may cause the learning aid to respond in a different, predetermined manner. For example, special instructions may be provided for hearing impaired children that cause the volume of the speaker to either increase or be muted, depending upon the severity of the impairment.

Optical Code Reader

Referring now to FIGS. 2A through 2C, the optical code reader 200 is preferably located in a recessed cavity at the bottom of the card holder. The reader 200 preferably has one LED 203 and one photodetector 204 for each code cell. The LED 203 preferably illuminates the cell of the learning card 20 at a 90° angle relative to the card surface and the photodetector senses the energy reflected at a 45° angle, as best shown in FIG. 2C. The LED 203 is preferably disposed within 90° angle bore 201 and the photodetector 204 is preferably disposed within 45° angle bore 202.

The observation aperture is sized to allow considerable tolerance in printing alignment and position in the holder. The 12 cells are preferably sequentially scanned and verified approximately 10 times per second.

Optionally, the optical code reader performs a self-test, such as prior to having a card inserted into the learning aid. The self test assures that the sensors are functioning correctly and that none of the light paths are obstructed. If a problem occurs during the self-test, then instructions may be given to remedy the problem. For example, audible and/or visual instructions may be given to clean the optical code reader.

Input/Output Relationships

Learning aid 10 may be preprogrammed with multiple sets of input/output relationships wherein each set corresponds to a particular lesson card 20. In such an instance, identification of card 20 identifies the set of relationships to be applied. In other instances, card 20 may comprise sufficient data (such as optically encoded data) to establish all or portions of a set of relationships, in essence programming learning aid 10 how to respond to particular inputs.

Alternate Characterizations

It is important to note that the learning system disclosed herein embodies numerous novel features that, individually and in combination, distinguish it from prior art learning systems. As such, it may be characterized in a number of ways using one or more of such features. The following paragraphs provide some exemplary characterizations, but the list is not exhaustive as other combinations are contemplated and would be readily apparent to one of average skill in the art after reading this disclosure.

Some embodiments may be characterized as an educational system comprising a learning aid that is adapted to receive a lesson card wherein: the learning aid comprises a plurality of switches positioned to underlie a lesson card received by the learning aid, and each of the plurality of switches is adapted to be momentarily activated by manually applying pressure to a portion of the lesson card; the switches are electronically coupled to one or more output devices such that toggling at least one of the switches will result in output from at least one of the output devices; the learning aid comprises one or more sensors for obtaining data from a lesson card received by the aid; and the learning aid is adapted to utilize the obtained data (a) in determining whether output will be generated, and (b) determining the form of the output, when any of the plurality of switches is activated.

In addition, such embodiments may, in some instances, be characterized by stating that the one or more sensors comprise at least one light sensor. In addition, such embodiments may in some instances be characterized by stating that the at least one light sensor is part of a sensor array that includes a plurality of photocells and at least one light source. In addition, such embodiments may in some instances be characterized by stating that the sensor array comprises a plurality of light sources where each light source is associated with a single photocell and light guide combination. In addition, such embodiments may in some instances be characterized by stating that each light guide of each of the combinations is adapted to direct reflected light from a light source of the combination to a photocell of the combination, and to inhibit light from light sources of any other combination from reaching the photocell.

Other embodiments may be characterized as comprising a learning aid adapted to receive a lesson card and to use optical sensors to identify the card.

Other embodiments may be characterized as an educational system comprising a lesson card comprising a plurality of regions adapted to optically identify the card. In addition, such embodiments may in some instances be characterized in that various regions comprise a plurality of black and white strips printed on a surface of the card. In addition, such embodiments may in some instances be characterized by stating that the system also comprises a learning aid comprising a plurality of switches, and the lesson card comprises a plurality of images positioned to overlay the plurality of switches.

Other embodiments may be characterized as a method of identifying a lesson card comprising: (a) providing the card with a plurality of optical strips and (b) wherein each optical strip is either white or black and formed by printing ink onto a portion of a surface of the lesson card.

Other embodiments may be characterized as a method of educating comprising: (a) prompting a user to press on one or more portions of a lesson card positioned on/in a learning aid that previously identified the card through the use of an optical code reader, and (b) having the learning aid provide audio and/or visual feedback to the user after the user presses the one or more portions of the lesson card.

Other embodiments may be characterized as a method of marking a lesson card comprising forming a plurality of black and white regions on the card in a pattern that a learning aid associates with a value that identifies the card.

Thus, specific embodiments and applications of learning systems have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. An educational system comprising a learning aid and a lesson card, the learning aid being adapted to receive the lesson card and to use optical sensors to identify the lesson card.

2. The system of claim 1, wherein the lesson card comprises at least one area that is configured to facilitate optical identification of the card.

3. The system of claim 2, wherein the area comprise a plurality of black and white strips printed on a surface of the lesson card.

4. The system of claim 1, wherein the learning aid further comprises a plurality of switches and the lesson card has a plurality of images positioned thereon so as to overlay at least some the plurality of switches.

5. An educational system comprising a learning aid that is adapted to receive a lesson card wherein:
the learning aid comprises a plurality of switches positioned so as to underlie the lesson card when the lesson card is received by the learning aid, and each of the plurality of switches is adapted to be at least momentarily activated by applying pressure to a portion of the lesson card;
the switches are in electrical communication with one or more output devices, such that activating at least one of the switches will result in output from at least one of the output devices;
the learning aid comprises one or more sensors for obtaining data from the lesson card received by the learning aid; and
the learning aid is adapted to utilize the obtained data in determining whether output will be generated and the form of the output, when any of the plurality of switches is activated.

6. The system of claim 5 wherein the one or more sensors comprise at least one light sensor.

7. The system of claim 6 wherein the at least one light sensor is part of a sensor array that includes a plurality of photocells and at least one light source.

8. The system of claim 7 wherein the sensor array comprises a plurality of light sources where each light source is associated with a single photocell and light guide combination.

9. The system of claim 8 wherein each light guide of each of the combinations is adapted to direct reflected light from a light source of the combination to a photocell of the combination, and to inhibit light from light sources of any other combination from reaching the photocell.

10. A method of making a lesson card, the method comprising forming an optically encoded area on the card in a pattern that facilitates identification of the card.

11. The method as recited in claim 10, wherein the optically encoded area on the card comprises a black and white optically encoded area.

12. The method as recited in claim 10, wherein the optically encoded area comprises a plurality of colored strips.

13. The method as recited in claim 10, wherein the optically encoded area comprises a plurality of strips that are printed upon a surface of the lesson card.

14. A method of educating comprising prompting a user to press one or more portions of a lesson card that is disposed proximate a learning aid, wherein the learning aid has identified the lesson card through the use of an optical code reader, and having the learning aid provide audio and/or visual feedback to the user after the user presses the one or more portions of the lesson card.
